(19) United States
(12) Patent Application Publication
(10) Pub. No.: US 2008/0260026 A1
(43) Pub. Date: Oct. 23, 2008

(54) Moving-picture coding apparatus, method and program

(75) Inventor: Mitsuo Harumatsu, Yokohama-shi (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Victor Company of Japan, Ltd., a corporation of Japan, Yokohama-shi (JP)

(21) Appl. No.: 11/903,691

(22) Filed: Sep. 24, 2007

(30) Foreign Application Priority Data
Sep. 25, 2006 (JP) 2006-258235
Jun. 29, 2007 (JP) 2007-171971

(51) Int. Cl. H04N 7/32

(52) U.S. Cl. 375/240.12; 375/E07.243

(57) ABSTRACT

Decoded is a first stream carrying moving-picture signals coded with a first coding scheme with a first intra-picture coding and an inter-picture coding technique, thus generating decoded moving-picture data. Picture-type information on each frame or field picture of the decoded moving-picture data is generated. The picture-type information indicates a first picture type or a second picture type. The first picture type is for each picture coded with the first intra-picture coding technique whereas the second picture type is for each picture coded with the inter-picture coding technique. The decoded moving-picture data is encoded with a second coding scheme with a second intra-picture coding technique, thus generating a second stream. Auxiliary information areas are created in the second stream. Each auxiliary information area is accessible in relation to each picture of the decoded moving-picture data. The picture-type information is inserted into the auxiliary information areas.

### CROSS-REFERENCE TO RELATED APPLICATIONS

This application is based on and claims the benefit of priority from the prior Japanese Patent Application Nos. 2006-258235 filed on Sep. 25, 2006 and 2007-171971 filed on Jun. 29, 2007, the entire contents of which is incorporated herein by reference.

### BACKGROUND OF THE INVENTION

The present invention relates to a moving-picture coding apparatus, method and program. Particularly, this present invention relates to a moving-picture coding apparatus, method and program with a coding scheme, such as MPEG (Moving Picture Experts Group) that is a combination of intra-picture coding and inter-picture coding techniques, and another coding scheme, such as DV (Digital Video) with an intra-picture coding technique.

A moving-picture signal obtained via a video camera or a camcorder is usually coded into a moving-picture coded signal with an MPEG coding scheme, and recorded and stored by a recorder installed in or attached to the video camera. When this signal coded in an MPEG format is transferred to another recording apparatus for dubbing via a DV terminal, a standard digital interface (I/F) for video cameras, it has to be transcoded into a DV format.

The MPEG coding scheme converts pictures (frames or fields) of a moving-picture signal into any of the picture types: I-picture, P-picture and B-picture. The I-picture is an intra-coded picture that is coded using only information from within that picture. The P-picture is a predicted picture that is coded with inter-picture prediction using previous I- or P-picture as a predictive picture. The B-picture is a bidirectional picture that is coded with inter-picture prediction using a previous and a future I- or P-picture as predictive pictures. The I-picture has higher quality (S/N) than the P-picture. And, the P-picture has higher quality (S/N) than the B-picture.

In contrast, the DV coding scheme converts pictures (frames or fields) of a moving-picture signal into one picture type, an intra-coded picture that is coded using only information from within that picture.

Transcoding of a moving-picture signal coded in the MPEG format into the DV format usually requires to decode the MPEG-coded signal into a decoded moving-picture signal and then encode this decoded signal with the DV coding scheme. The moving-picture signal thus inevitably loses coding information, indicating that each picture carried by this signal is any one of the I-, P- or B-pictures in the MPEG format, when decoded into the decoded moving-picture signal.

There is a need to record a moving-picture signal, that has been transcoded from the MPEG to DV format as described above, onto a DVD. This requires re-transcoding of the DV format of the moving-picture signal into the MPEG format because DVDs employ the MPEG coding scheme.

The moving-picture signal transcoded from the MPEG to DV format has no coding information (picture-type information) on whether each picture carried by this signal was an I-, a P- or a B-picture when previously coded with the MPEG coding scheme, as discussed above.

In encoding the moving-picture signal coded in the DV format again with the MPEG coding scheme, in order to record this signal on a DVD in the MPEG format, there are pictures that are P- or B-pictures previously coded with the MPEG coding scheme are coded as I-pictures. The pictures coded as the I-pictures do not have higher quality (S/N) than when they were the P- or B-pictures previously. The pictures coded as the I-pictures with the MPEG coding scheme thus inevitably have lower quality (S/N) even though they are used as reference pictures in coding P- and B-pictures with the MPEG coding scheme. The P- and B-pictures coded with reference to the pictures coded as the I-pictures thus have much lower quality (S/N). Therefore, the moving-picture signal transcoded again into the MPEG format has much lower quality (S/N) than the original MPEG-format moving-picture signal.

A known bitstream transfer apparatus transfers a bitstream with several coding parameters (coding-history information) used in prior coding, to achieve efficient re-encoding. When P- or B-pictures are coded again, a coding parameter (coding-history information) used in prior coding for the same picture type is searched and when there is such a coding parameter, a motion vector at that time of coding is used for re-encoding, to achieve decrease in motion vectors in re-encoding, aiming for efficient re-encoding with less lodes.

In the known bitstream transfer apparatus, however, coding parameters (coding-history information) are included in a bitstream as user data, which causes increase in the amount of data to be transferred.

Moreover, the known bitstream transfer apparatus enables re-encoding in the same coding format (particularly MPEG) only, or does not offer transcoding between different coding formats. For example, a moving-picture signal coded with the MPEG coding scheme cannot be coded with the DV coding scheme and coded further with the MPEG coding scheme, like discussed above, in the known apparatus.

### SUMMARY OF THE INVENTION

A first purpose of the present invention is to provide a moving-picture coding apparatus, method and program that allows re-encoding with an inter-picture coding scheme, such as MPEG, and then an intra-picture coding scheme, such as DV, and maintains picture-type information on pictures of a moving-picture signal coded at the time of inter-picture coding scheme, with fewer code amount.

A second purpose of the present invention is to provide a moving-picture coding apparatus, method and program that encodes the moving-picture signal coded with the intra-picture coding scheme by the apparatus, method and program mentioned in the first purpose, with the inter-picture coding scheme according to the picture-type information on pictures when coded previously with the inter-picture coding scheme, to maintain picture quality (S/N) of the original coded signal.

The present invention provides a moving-picture coding apparatus comprising: a decoder to decode a first stream carrying moving-picture signals coded with a first coding scheme with a first intra-picture coding technique and an inter-picture coding technique, thus generating decoded moving-picture data; a generator to generate picture-type information on each frame or field picture of the decoded moving-picture data, the picture-type information indicating a first picture type or a second picture type, the first picture type being for each picture coded with the intra-picture coding technique and the second picture type being for each picture coded with the inter-picture coding technique; and an encoder to encode the decoded moving-picture data with a second coding scheme with a second intra-picture coding technique, thus generating a second stream, and create auxiliary information areas in the second stream, each auxiliary information area being accessible in relation to each picture of the decoded moving-picture data, and insert the picture-type information into the auxiliary information areas.

Moreover, the present invention provides a moving-picture coding apparatus comprising: a decoder to decode a first stream that is originally moving-picture data coded with a first coding scheme with a first intra-picture coding technique and an inter-picture coding technique and then coded again, after decoded, with a second coding scheme with a second intra-picture coding technique, thus generating decoded moving-picture data; an extractor to extract picture-type information from the first stream, the picture-type information being inserted into auxiliary information areas of the first stream, the auxiliary information areas being accessible in relation to each frame or field picture of the decoded moving-picture data, the picture-type information indicating a first picture type or a second picture type, the first picture type being for each picture coded with the first intra-picture coding technique and the second picture type being for each picture coded with the inter-picture coding technique; and an encoder to encode the decoded moving-picture data with the first coding scheme according to the picture-type information, thus generating a second stream.

Furthermore, the present invention provides a moving-picture coding apparatus comprising: a decoder to decode a first stream that is originally moving-picture data coded with a first coding scheme with first intra-picture coding and inter-picture coding techniques and then coded again, after decoded, with a second coding scheme with a second intra-picture coding technique, thus generating decoded moving-picture data; an extractor to extract picture-type information from the first stream, the picture-type information being inserted into auxiliary information areas of the first stream, the auxiliary information areas being accessible in relation to each frame or field picture of the decoded moving-picture data, the picture-type information indicating a first picture type or a second picture type, the first picture type being for each picture coded with the first intra-picture coding technique and the second picture type being for each picture coded with the first inter-picture coding technique; and an encoder to encode the decoded moving-picture data with a third coding scheme with a third intra-picture coding technique and a second inter-picture coding technique, different from the first coding scheme, according to the picture-type information, thus generating a second stream.

Moreover, the present invention provides a moving-picture coding method comprising the steps of: decoding a first stream carrying moving-picture signals coded with a first coding scheme with a first intra-picture coding technique and an inter-picture coding technique, thus generating decoded moving-picture data; generating picture-type information on each frame or field picture of the decoded moving-picture data, the picture-type information indicating a first picture type or a second picture type, the first picture type being for each picture coded with the first intra-picture coding technique and the second picture type being for each picture coded with the inter-picture coding technique; and encoding the decoded moving-picture data with a second coding scheme with a second intra-picture coding technique, thus generating a second stream, and creating auxiliary information areas in the second stream, each auxiliary information area being accessible in relation to each picture of the decoded moving-picture data, and inserting the picture-type information into the auxiliary information areas.

Furthermore, the present invention provides a moving-picture coding method comprising the steps of: decoding a first stream that is originally moving-picture data coded with a first coding scheme with a first intra-picture coding technique and an inter-picture coding technique and then coded again, after decoded, with a second coding scheme with a second intra-picture coding technique, thus generating decoded moving-picture data; extracting picture-type information from the first stream, the picture-type information being inserted into auxiliary information areas of the first stream, the auxiliary information areas being accessible in relation to each frame or field picture of the decoded moving-picture data, the picture-type information indicating a first picture type or a second picture type, the first picture type being for each picture coded with the first intra-picture coding technique and the second picture type being for each picture coded with the inter-picture coding technique; and encoding the decoded moving-picture data with the first coding scheme according to the picture-type information, thus generating a second stream.

Moreover, the present invention provides a moving-picture coding method comprising the steps of: decoding a first stream that is originally moving-picture data coded with a first coding scheme with first intra-picture coding and inter-picture coding techniques and then coded again, after decoded, with a second coding scheme with a second intra-picture coding technique, thus generating decoded moving-picture data; extracting picture-type information from the first stream, the picture-type information being inserted into auxiliary information areas of the first stream, the auxiliary information areas being accessible in relation to each frame or field picture of the decoded moving-picture data, the picture-type information indicating a first picture type or a second picture type, the first picture type being for each picture coded with the first intra-picture coding technique and the second picture type being for each picture coded with the first inter-picture coding technique; and encoding the decoded moving-picture data with a third coding scheme with a third intra-picture coding technique and a second inter-picture coding technique, different from the first coding scheme, according to the picture-type information, thus generating a second stream.

Furthermore, the present invention provides a moving-picture coding program, in a computer readable medium, for encoding moving-picture signals comprising: a decoding program code of decoding a first stream carrying moving-picture signals coded with a first coding scheme with a first intra-picture coding technique and an inter-picture coding technique, thus generating decoded moving-picture data; a generating program code of generating picture-type information on each frame or field picture of the decoded moving-picture data, the picture-type information indicating a first picture type or a second picture type, the first picture type being for each picture coded with the first intra-picture coding technique and the second picture type being for each picture coded with the inter-picture coding technique; and an encoding program code of encoding the decoded moving-picture data with a second coding scheme with a second intra-picture coding technique, thus generating a second stream, and creating auxiliary information areas in the second stream, each auxiliary information area being accessible in relation to each picture of the decoded moving-picture data, and inserting the picture-type information into the auxiliary information areas.

Furthermore, the present invention provides a moving-picture coding program, in a computer readable medium, for encoding moving-picture signals comprising: a decoding program code of decoding a first stream that is originally moving-picture data coded with a first coding scheme with a first intra-picture coding technique and an inter-picture coding technique and then coded again, after decoded, with a second coding scheme with a second intra-picture coding technique, thus generating decoded moving-picture data; an extracting program code of extracting picture-type information from the first stream, the picture-type information being inserted into auxiliary information areas of the first stream, the auxiliary information areas being accessible in relation to each frame or field picture of the decoded moving-picture data, the picture-type information indicating a first picture type or a second picture type, the first picture type being for each picture coded with the first intra-picture coding technique and the second picture type being for each picture coded with the inter-picture coding technique; and an encoding program code of encoding the decoded moving-picture data with the first coding scheme according to the picture-type information, thus generating a second stream.

Still, furthermore, the present invention provides a moving-picture coding program, in a computer readable medium, for encoding moving-picture signals comprising: a decoding program code of decoding a first stream that is originally moving-picture data coded with a first coding scheme with first intra-picture coding and inter-picture coding techniques and then coded again, after decoded, with a second coding scheme with a second intra-picture coding technique, thus generating decoded moving-picture data; an extracting program code of extracting picture-type information from the first stream, the picture-type information being inserted into auxiliary information areas of the first stream, the auxiliary information areas being accessible in relation to each frame or field picture of the decoded moving-picture data, the picture-type information indicating a first picture type or a second picture type, the first picture type being for each picture coded with the first intra-picture coding technique and the second picture type being for each picture coded with the first inter-picture coding technique; and an encoding program code of encoding the decoded moving-picture data with a third coding scheme with a third intra-picture coding technique and a second inter-picture coding technique, different from the first coding scheme, according to the picture-type information, thus generating a second stream.

### BRIEF DESCRIPTION OF DRAWINGS

FIG. 1 indicates change in S/N per picture type of an MPEG stream re-coded with no consideration of picture types of an original MPEG stream;

FIG. 2 indicates change in S/N per picture type of an MPEG stream re-coded under consideration of picture types of the original MPEG stream;

FIG. 3 shows a block diagram of a moving-picture coding system including MPEG-to-DV and DV-to-MPEG coding apparatuses according to the present invention;

FIG. 4 illustrates a data structure for one track of DV data in a magnetic tape and a data structure in a video area of the DV data;

FIG. 5 illustrates DIF sequences in transfer of the DV data;

FIG. 6 shows a detailed structure of each DIF sequence;

FIG. 7 illustrates a UX structure in one track of a recording medium;

FIG. 8 illustrates VAUX-pack zones in auxiliary zones for one frame (10 tracks);

FIG. 9 illustrates a data structure of a subcode area in one track;

FIG. 10 illustrates a subcode structure of one frame (10 tracks);

FIG. 11 shows an exemplary illustration of VAUX BINARY GROUP inserted with picture-type information;

FIG. 12 shows an exemplary illustration of MAKER CODE PACK followed by an optional pack inserted with the picture-type information;

FIG. 13 shows a block diagram indicating a detailed structure of an MPEG-to-DV coding apparatus, an embodiment of the present invention;

FIG. 14 shows a flowchart of an MPEG-stream writing procedure executed by MPEG-to-DV coding apparatus according to the present invention;

FIG. 15 shows a flowchart of an MPEG-stream decoding procedure executed by the MPEG-to-DV coding apparatus according to the present invention;

FIG. 16 shows a flowchart of a DV coding procedure executed by the MPEG-to-DV coding apparatus according to the present invention;

FIG. 17 shows a flowchart of a DV-data output procedure executed by the MPEG-to-DV coding apparatus according to the present invention;

FIG. 18 shows a block diagram indicating a detailed structure of a DV-to-MPEG coding apparatus, an embodiment of the present invention;

FIG. 19 shows a flowchart of a DV-data writing procedure executed by the MPEG-to-DV coding apparatus according to the present invention;

FIG. 20 shows a flowchart of a DV-data decoding procedure executed by the MPEG-to-DV coding apparatus according to the present invention; and

FIG. 21 shows a flowchart of an MPEG coding procedure executed by the MPEG-to-DV coding apparatus according to the present invention.

### DETAILED DESCRIPTION OF PREFERRED EMBODIMENT

Discussed before an embodiment of the present invention is a basic principle applied to the present invention.

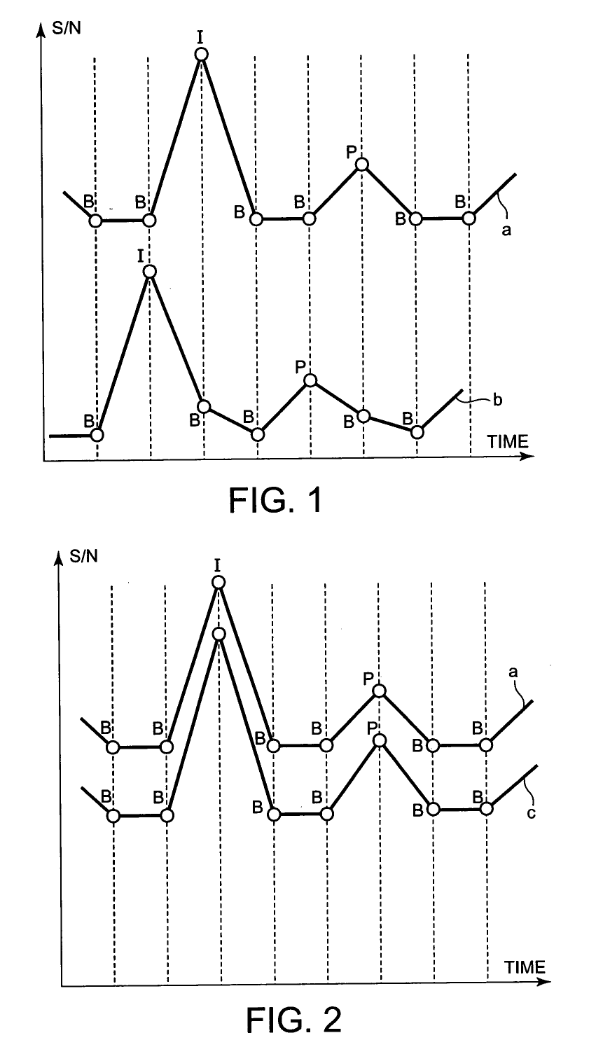

FIG. 1 shows curves “a” and “b” indicating change in S/N of an MPEG-format moving-picture coded signal depending on the picture types: I-picture, P-picture or B-picture. In detail, the curve “a” indicates change in S/N depending on the picture types when coded by MPEG coding at first. The curve “b” indicates change in S/N of the moving-picture coded signal depending on the picture types when coded again by MPEG coding, with B-pictures coded as an I-picture. FIG. 1 teaches that when an MPEG-format moving-picture signal is coded again by MPEG coding in which B-pictures on the curve “a” are coded as I-pictures, the moving-picture signal suffers decrease in S/N drastically, as shown in the curve “b”.

FIG. 2 shows the same curve “a” as in FIG. 1 and a curve “c” indicating change in S/N depending on the picture types: I-picture, P-picture or B-picture. In detail, the curve “c” indicates change in S/N of the MPEG-format moving-picture signal depending on the picture types when the signal is coded again by MPEG coding in which the I-pictures, P-pictures and B-pictures are coded as I-, P- and B-pictures, respectively, or coded as the same picture type. Compared to the curve “b” in FIG. 1, the curve “c” in FIG. 2 has S/N much closer to the curve “a”, or decrease in S/N is much restricted in the curve “c”. The present invention employs the principle shown in FIG. 2.

Now, an embodiment of the present invention is disclosed.

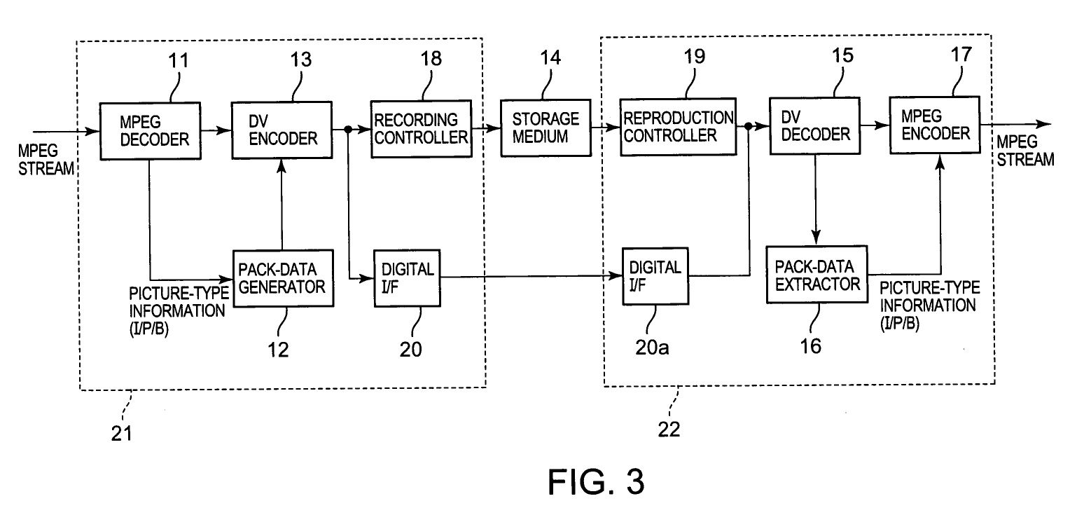

FIG. 3 shows a moving-picture coding system according to the present invention.

The moving-picture coding system includes a first moving-picture coding apparatus, an MPEG-to-DV coding apparatus 21, and a second moving-picture coding apparatus, a DV-to-MPEG coding apparatus 22.

The MPEG-to-DV coding apparatus 21 is equipped with an MPEG decoder 11, a pack-data generator 12, a DV encoder 13, and a recording controller 18.

The DV-to-MPEG coding apparatus 22 is equipped with a reproduction controller 19, a DV decoder 15, a pack-data extractor 16, and an MPEG encoder 17.

A moving-picture signal coded at the MPEG-to-DV coding apparatus 21 is transferred to the DV-to-MPEG coding apparatus 22 via a storage medium 14, such as, a magnetic tape, a hard disc, an optical disc and a semiconductor memory (a non-volatile memory), in an offline transfer mode.

The MPEG-to-DV coding apparatus 21 and the DV-to-MPEG coding apparatus 22 also include digital interfaces (I/F) 20 and 20a, respectively, that enable transfer of a moving-picture coded signal from the apparatuses 21 to 22 in an online transfer mode for real-time bitstream transfer or asynchronous file transfer.

The MPEG-to-DV coding apparatus 21 is described first in detail.

The MPEG decoder 11 receives a first MPEG stream that is a moving-picture coded data strain coded with the MPEG coding scheme. The decoder 11 decodes the first MPEG stream to generate decoded video data and supplies the decoded video data to the DV encoder 13. Moreover, the decoder 11 detects and obtains coding information carried by the first MPEG stream.

The coding information is inserted into a picture header, for each picture, in the first MPEG stream. Not only the picture header, such coding information may be inserted into a sequence header, for each sequence layer, in the first MPEG stream.

The MPEG decoder 11 extracts picture-type information from the coding information. The picture-type information indicates whether each picture (a frame or field) of the decoded video data was originally an I-, a P- or a B-picture when coded previously. The picture-type information is then sent to the pack-data generator 12.

The pack-data generator 12 generates pack data that caries auxiliary information accessible in relation to each picture and the picture-type information sent from the MPEG decoder 11.

The DV encoder 13 encodes the decoded video data sent from the MPEG decoder 11, with an intra-coding scheme per picture, in this case, the DV coding scheme known for video cameras. Moreover, the DV encoder 13 inserts the pack data sent from the pack-data generator 12 into a specific area in the intra-coded video data for each picture, to generate DV data.

The DV data is sent to the recording controller 18 and recorded in the storage medium 14.

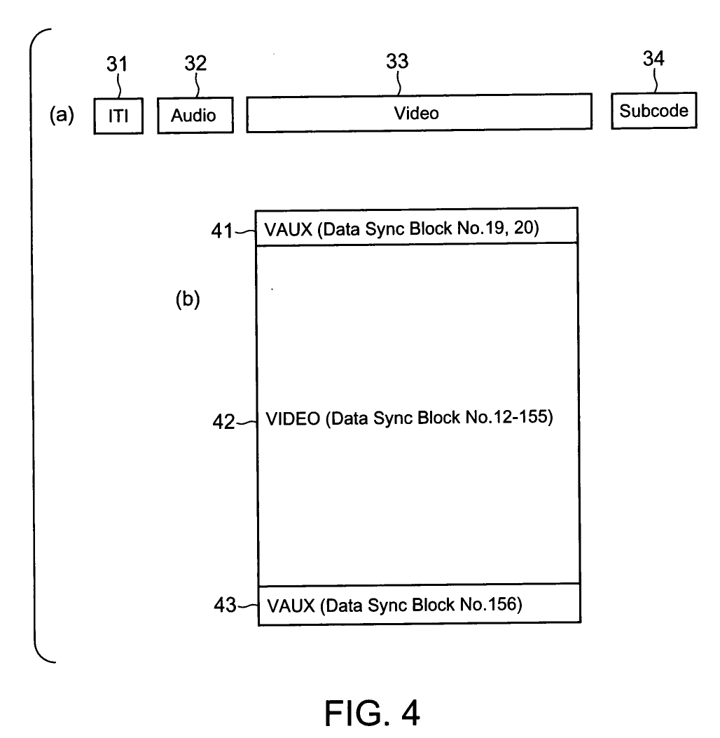

Illustrated in (a) of FIG. 4 is a data structure for one track of the DV data when the storage medium 14 is a magnetic tape.

The DV data consists of ITI (Insert and Track Information) area 31, an audio area 32, a video area 33, and a subcode area 34 in one track.

A one-frame DV data is recorded along 10 tracks and 12 tracks for NTSC video signals and PAL video signals, respectively.

The ITI area 31 is mainly used in insert recording of new DV data in tracks already formed with the currently-recorded DV data. In insert recording, data is reproduced from the ITI area 31 via a rotary head (not shown) while the relative positional relationship between the rotary head and the tracks is under control by a tape travel controller (not shown).

Audio, video and subcode data of the generated DV data are then overwritten in the audio area 32, the video area 33, and the subcode area 34, respectively.

In initial recording of the DV data on the magnetic tape, all of the DV data are recorded including data of the ITI area 31. Data for the ITI area 31 is, however, not transferred to the recording controller 18. Instead, the recording controller 18 generates data for the ITI area 31 and records this data in the storage medium 14 (magnetic tape) with other data.

The DV data is recorded in DIF (Data Interchange Format) or another format similar to DIF when the storage medium 14 is a disc storage medium, which does not require the ITI area 31.

Recorded in the audio area 32, the video area 33, and the subcode area 34 are an audio signal, several types of auxiliary information in recording, and a moving-picture signal, respectively.

Illustrated in (b) of FIG. 4 is a data structure in the video area 33 of the DV data.

The video area 33 consists of: an auxiliary zone (VAUX-pack zone) 41 provided to 2 sync blocks of data sync block Nos. 19 and 22; a video recording zone 42 provided to 144 sync blocks of data sync block Nos. 12 to 155; and an auxiliary zone (VAUX-pack zone) 43 provided to one sync block of a data sync block No. 156.

Each data sync block has a 90-byte fixed-length data structure which is well known in the art and not directly related to the feature of the present invention, and hence explanation thereof is omitted.

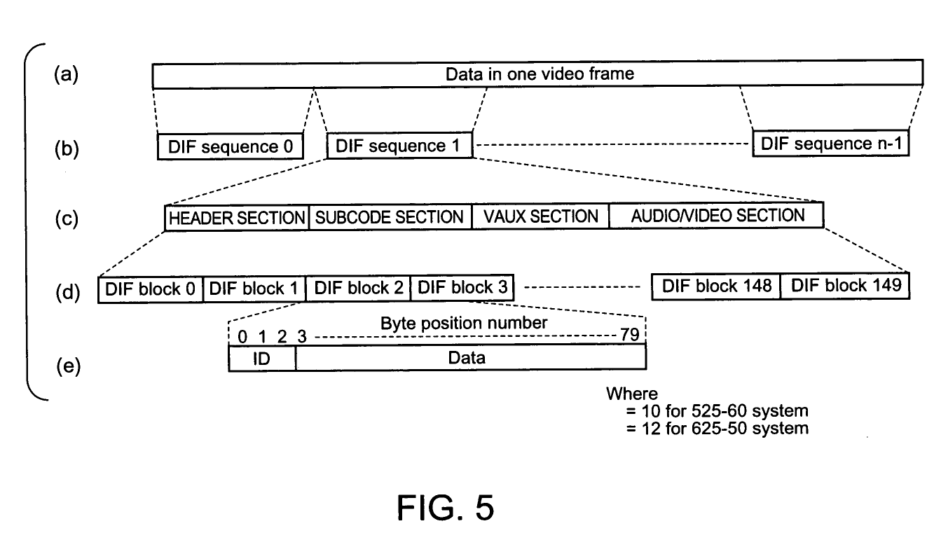

In transfer of the DV data via the digital I/F 20 and 20a (FIG. 3), the data is transferred in a data structure having DIF sequences as illustrated in FIG. 5.

Illustrated in (a) to (e) of FIG. 5 are one frame of the DV data, DIF sequences, one DIF sequence, DIF blocks, and one DIF block, respectively.

Shown in (b) of FIG. 5 is one frame of the DV data composed of “n” number DIF sequences. The number “n” is 10 for the DV data of an NTSC video signal whereas 12 for a PAL video signal.

Each DIF sequence consists of a header section, a subcode section, a VAUX section, and an audio/video section, as shown in (c) of FIG. 5. Moreover, each DIF sequence consists of 150 DIF blocks, as shown in (d) of FIG. 5. Each DIF block consists of a 3-byte ID and 77-byte data, as shown in (e) of FIG. 5.

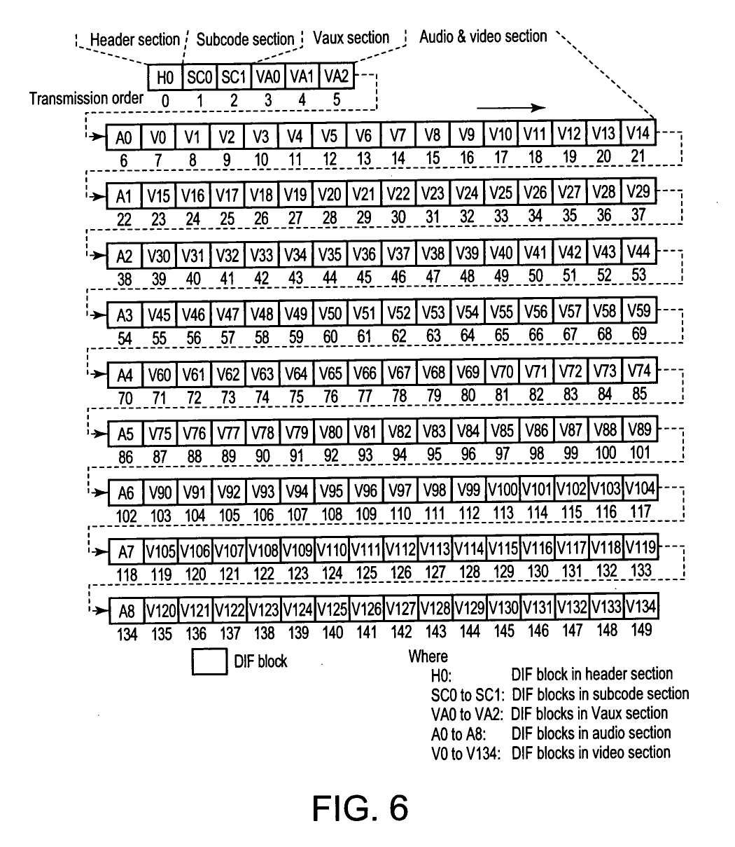

FIG. 6 shows a detailed structure of the 150 DIF blocks of each DIF sequence in (d) of FIG. 5.

In FIG. 6, H0, SC0 and SC1, VA0 to VA2, A0 to A8, V0 to V134 correspond to the header section, the subcode section, the VAUX section, the audio section, and the video section, respectively, shown in (c) of FIG. 5.

The DV data to be stored in the storage medium 14 may contain all of the data shown in FIGS. 4 and 5 or only the necessary data, with auxiliary information if required. The pack data that caries the picture-type information accessible in relation to frames is recorded in the video area 33, which may, however, be optionally recorded in the audio area 32 and/or the subcode area 34, shown in (a) of FIG. 4.

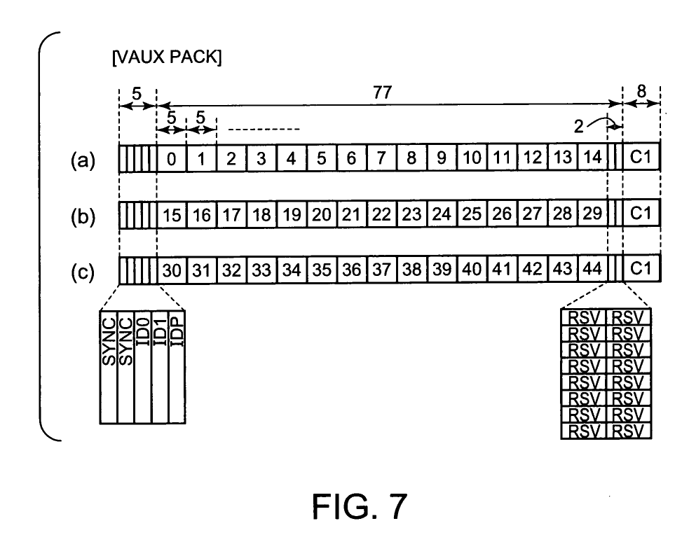

Illustrated in FIG. 7 are data structures of the auxiliary zones (VAUX-pack zones) 41 and 43 in one track, shown in (b) of FIG. 4.

Shown in (a), (b) and (c) of FIG. 7 are the data sync block No. 19 in the VAUX-pack zone 41, the data sync block No. 20 in the VAUX-pack zone 41, and one sync block of the VAUX-pack zone 43, respectively. One pack data consists of 5-byte data. The auxiliary zones (VAUX-pack zones) per track are divided into 45 (0 to 44) pack zones each for storing pack data.

Recorded in a 5-byte header of each sync block in (a), (b) and (c) of FIG. 7 is 2-byte sync information SYNC and identification information ID0, ID1 and ID2. Recorded in each zone C1 in (a), (b) and (c) of FIG. 7 is an 8-byte error-correction code (Reed-Solomon code) attached to 77-byte data. Zones RSV (reserved) are unused zones which usually store hexadecimal data “FF”.

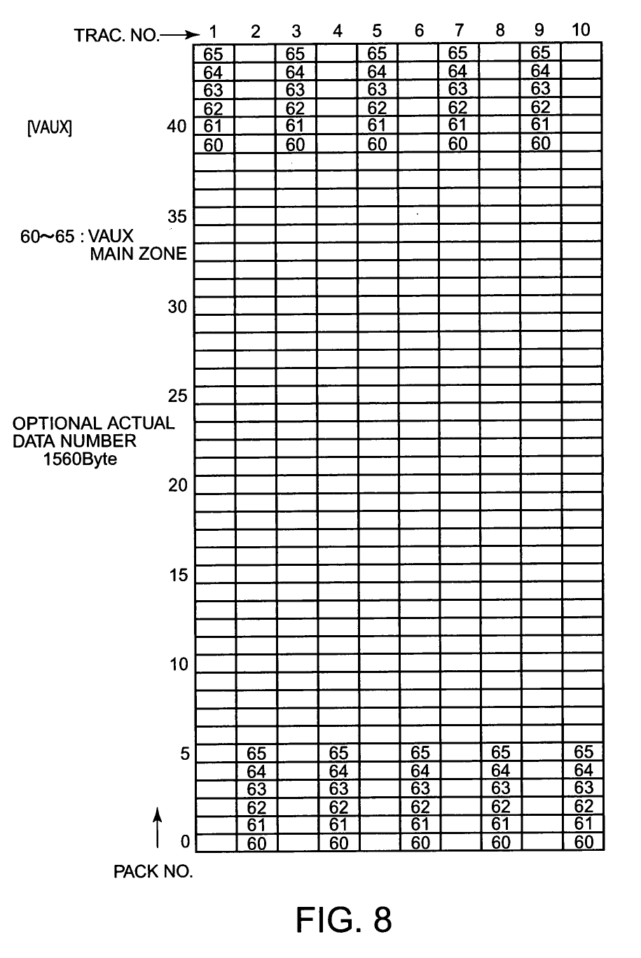

FIG. 8 illustrates VAUX-pack zones in auxiliary zones for one NTSC frame (10 tracks), with numerals 0, 5, 10, . . . 40 in the vertical direction and 1 to 10 in the horizontal direction indicating pack numbers and track numbers, respectively.

Pack data can be recorded in 45 pack zones (the pack numbers 0 to 44) in each track. Of the 45 pack zones, 6 pack zones with numerals 60 to 65 are main zones whereas the other 39 blank pack zones are optional zones. The main zones store specific types of data only. In contrast, the optional zones can store any type of data, such as, the pack data including the picture-type information.

It is preferable to record the pack data including the picture-type information in the auxiliary zones (VAUX-pack zones) 41 and 43 in the video area 33 because the picture-type information is related to video. Optionally, however, the pack data can be recorded in the optional pack zones in the audio area 32 and/or the subcode area 34, as discussed below.

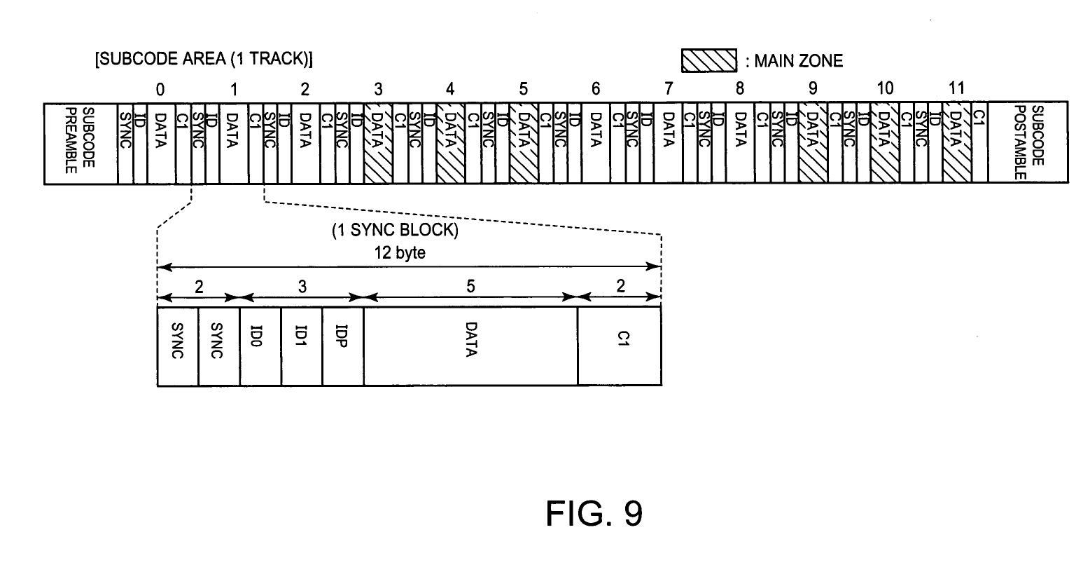

Illustrated in FIG. 9 is a data structure of the subcode area 34 shown in (a) of FIG. 4.

The subcode area 34 can store 12 (0 to 11) subcode packs. Each subcode pack has one sync block of 12-byte fixed-length. This one sync block consists of: 2-byte sync information SYNC; 1-byte identification information ID0, ID1 and IDP; 5-byte data DATA; and 2-byte parity C1. Main zones are data zones (DATA) with numerals 3, 4, 5, 9, 10 and 11, with slant lines.

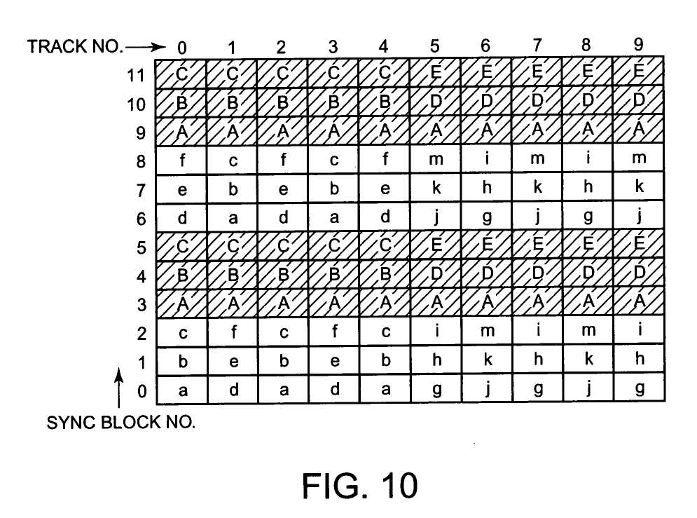

FIG. 10 illustrates a subcode structure of one NTSC frame (10 tracks), with numerals 0 to 11 in the vertical direction indicating sync block numbers (corresponding to 0 to 11, respectively, in FIG. 9) and 0 to 9 in the horizontal direction indicating track numbers. Main zones are those with capital letters and slant lines, for storing specific types of data only. In contrast, those with small letters are optional zones that can store any type of data, such as, the pack data including the picture-type information. The identical pack data can be recorded in several optional zones of the same small letter for higher recording reliability.

Described next in detail is the pack that stores the picture-type information. There are optional packs, such as, VAUX BINARY GROUP and MAKER CODE.

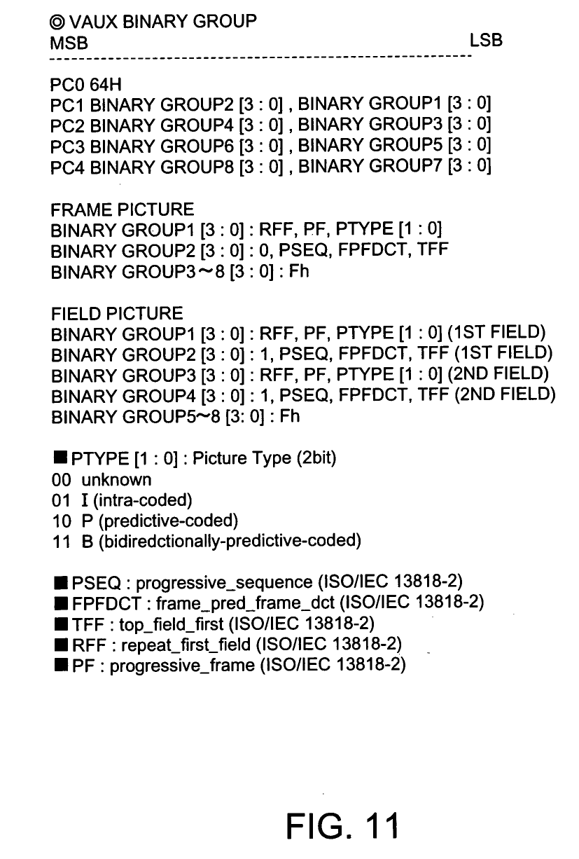

FIG. 11 is an exemplary illustration of VAUX BINARY GROUP inserted with the picture-type information.

In FIG. 11, the picture-type information (PICT TYPE) is inserted into 4 bytes of VAUX BINARY GROUR A picture type can be defined per field for MPEG coding per field. The picture-type information uses 4 bits: the upper 2 bits F2 for picture-type information on a second field; and the lower 2 bits F1 for picture-type information on a first field. The picture types of the first and second fields are the same for MPEG coding per frame. The 2-bit picture-type information on each field is defined as an I-picture, a P-picture or a B-picture when the binary value is “01”, “10” or “11”, respectively, for example. In addition, the picture-type information is defined as “unknown” at “00” for a unknown picture-type. Thus, the picture-type information indicates 4 states in total with 2 bits.

The DV coding scheme performs coding per frame. Transcoding from the MPEG to DV format thus requires one parameter for each of frames that were subjected to MPEG coding per frame. In contrast, transcoding requires information (parameter) on each of two fields of one frame as information for one frame when MPEG coding was performed per field.

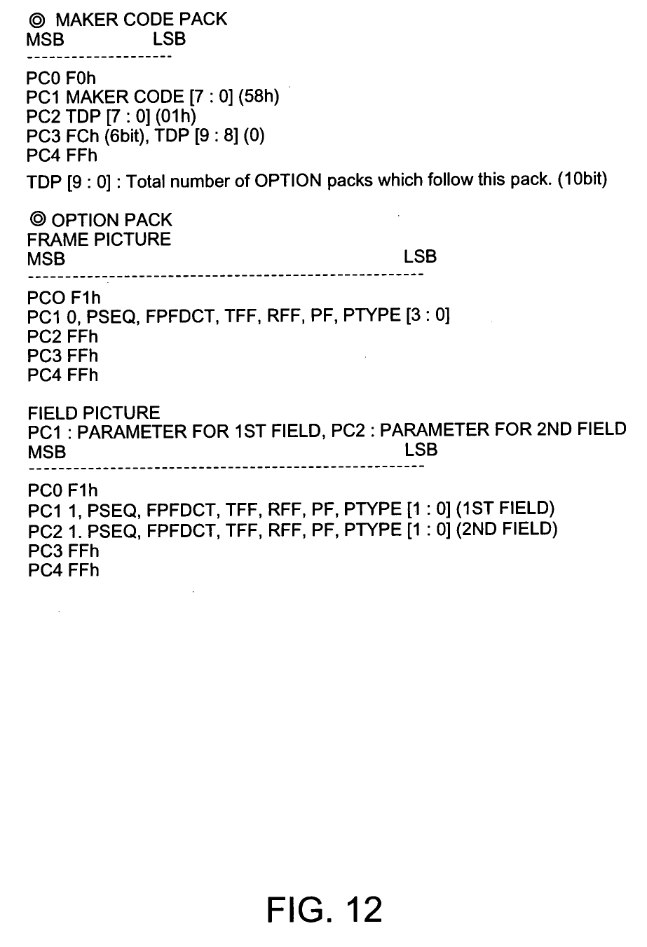

For the reason above, the pack data in FIG. 11 includes discrimination information that indicates whether the data carried by each pack results from MPEG coding per frame or per field. The same is applied to FIG. 12 which will be discussed later. In FIG. 11, BINARY GROUP2 [3:0] indicates a frame picture that was subjected to MPEG coding per frame whereas, although not shown, BINARY GROUP2 [3:1] indicates a field picture that was subjected to MPEG coding per field. BINARY GROUP4 [3:1] also indicates a field picture that was subjected to MPEG coding per field.

Other information also inserted in VAUX BINARY GROUP shown in FIG. 11 are: FPFDCT (frame-pred-frame-dct) indicating that frame prediction and frame DCT are only employed; PSEQ (progressive-sequence) indicating progressively scanned video sequence; TFF (top-field-first) indicating whether the top field is upper or lower for a frame picture; RFF (repeat-first-field) indicating that a picture is used in 2-3 pull down and the first field is repeatedly reproduced; and PF (progressive-frame) indicating that this picture is a progressively scanned video.

FIG. 12 is an exemplary illustration of MAKER CODE PACK followed by an optional pack inserted with the picture-type information. MAKER CODE PACK is a specific pack used with a maker identification code, for enhancing specific functions unique to each maker.

Included in MAKER CODE PACK is a 10-bit area TDP divided into zones PC2 and PC3, indicating the number of effective optional packs that follow MAKER CODE PACK. The number of optional packs that follow MAKER CODE PACK is one in FIG. 12. Thus, the 10-bit area TDP is given “1” (i.e., TDP [7:0]=1, TDP [9:8]=0).

The optional pack that follows MAKER CODE PACK includes 2-bit picture-type information PTYPE. The information PTYPE is written only in the zone PC1 of the optional pack when MPEG coding was performed per frame previously. In contrast, the information PTYPE on a first field and a second filed are written in the zone PC1 and the zone PC2, respectively, of the optional pack when MPEG coding was performed per field previously. PC1 [7:0] indicates a frame picture. PC1 [7:1] and PC2 [7:1] indicate a field picture.

The contents of the optional pack (OPTION PACK) is the same as that of the optional pack that follows VAUX BINARY GROUP shown in FIG. 11, except for a pack identification code (PCO).

The DV data can be transferred via the digital I/F 20 and 20a (FIG. 3), using any of the optional pack zones: the subcode section, the VAUX section or the audio/video section, shown in (c) of FIG. 5.

The MPEG-to-DV coding apparatus 21 shown in FIG. 3 is disclosed further in detail.

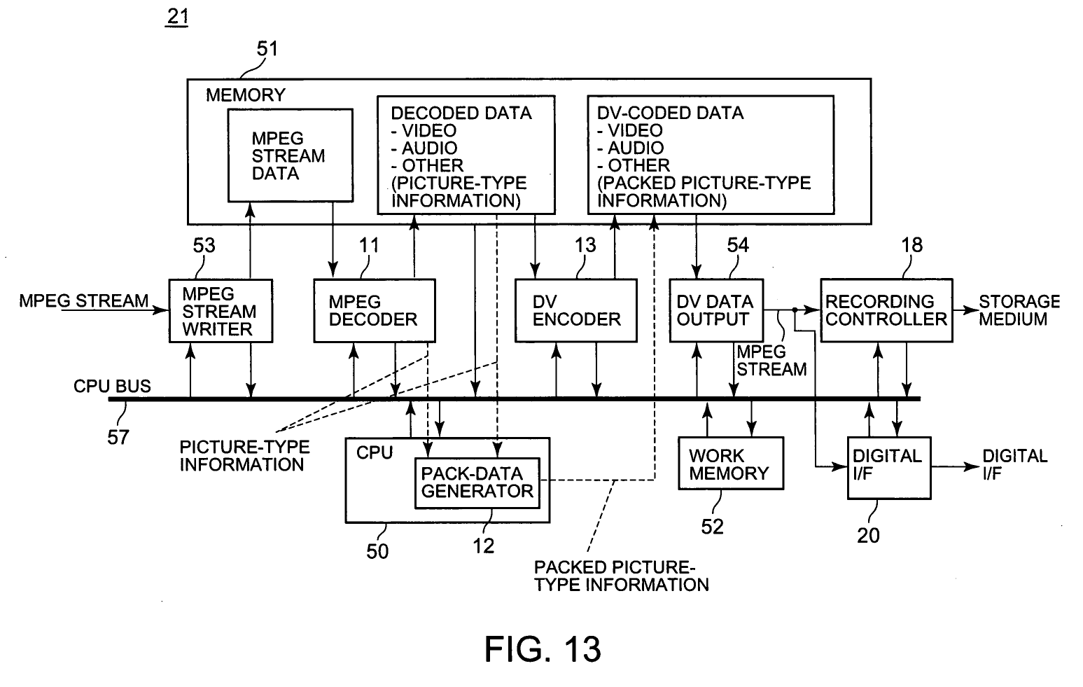

FIG. 13 shows a block diagram indicating a detailed structure of the MPEG-to-DV coding apparatus 21. Each block in FIG. 13 is under control by a CPU 50 via a CPU bus 57. The CPU 50 may be replaced by a DSP.

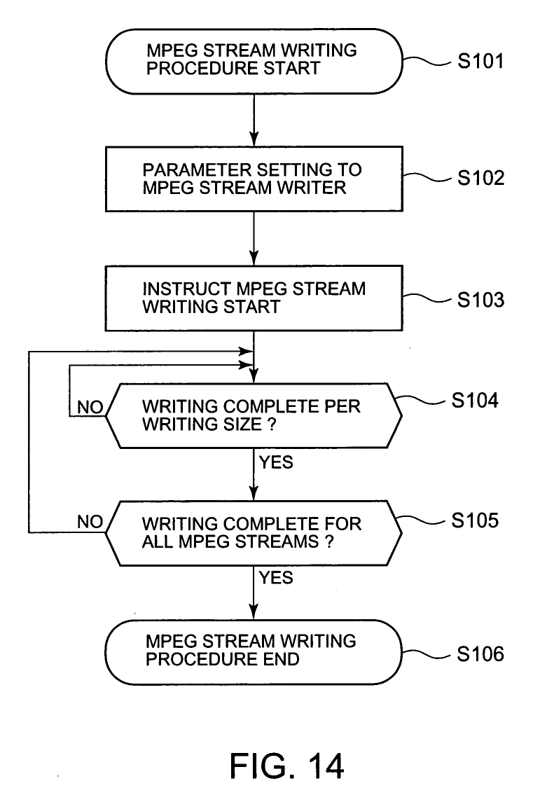

The function of the MPEG-to-DV coding apparatus 21, or the CPU 50, will be disclosed with reference to FIG. 13 and also flowcharts shown in FIGS. 14 to 17.

[MPEG-Stream Writing Procedure]

Disclosed first is an MPEG-stream writing procedure to write an input MPEG stream in the memory 51, with reference to FIG. 13 and the flowchart shown in FIG. 14.

The CPU 50 starts an MPEG-stream writing procedure (step S101).

The CPU 50 sets several parameters to an MPEG-stream writer 53 per unit of processing to the input MPEG stream, such as, a TS (Transport Stream) packet (step S102). The parameters are a writing start position, a writing size per processing of the input MPEG stream to the memory 51, etc. The parameter settings may be performed only once at the start of the writing procedure when the writing size of the MPEG stream is constant, for example, it is the TS packet. On the contrary, the parameter settings are performed per writing procedure when the writing size is different per writing procedure. For example, a writing-size parameter setting is performed per writing procedure depending on the number of packets to be processed (one packet or several packets per writing procedure), while scheduling is performed, depending on the progress of the procedure.

The CPU 50 instructs the MPEG-stream writer 53 to start an MPEG-stream writing (step S103).

On receiving the instruction from the CPU 50, the MPEG-stream writer 53 starts and repeats MPEG writing from a designated writing start point in the memory 51 per set writing size (steps S104 and S105).

The CPU 50 finishes the MPEG-stream writing procedure when it determines that all MPEG streams have been written (step S106).

[MPEG-Stream Decoding Procedure]

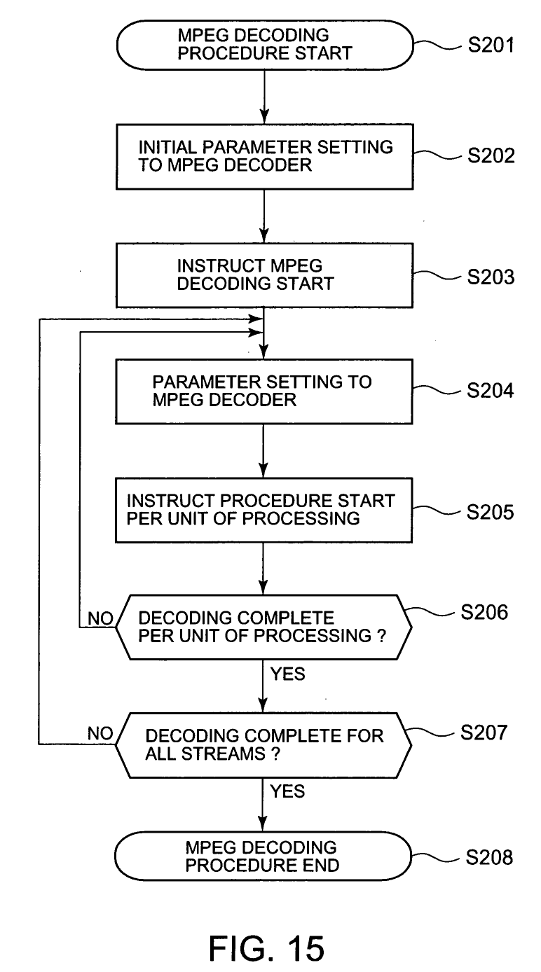

Disclosed next is an MPEG-stream decoding procedure to decode an MPEG stream written in the memory 51, with reference to FIG. 13 and the flowchart shown in FIG. 15.

The CPU 50 starts an MPEG-stream decoding procedure (step S201).

The CPU 50 sets several initial parameters to the MPEG decoder 11 (FIG. 3) per unit of processing, such as, a TS packet (step S202). The parameters are a reading start position, a reading size (depending on the unit of processing) of the MPEG streams written in the memory 51, etc.

The CPU 50 instructs the MPEG decoder 11 to start MPEG-stream decoding (step S203).

The CPU 50 sets the parameters mentioned above to the MPEG decoder 11 when the reading size varies per unit of processing (step S204). When the reading size is constant, however, step S204 may not be executed, the initial parameter settings (step S202) only being executed.

On receiving the instruction from the CPU 50, the MPEG decoder 11 reads an MPEG stream from a designated reading start point in the memory 51 depending on the unit of processing. Then, the MPEG decoder 11 detects an ID that indicates the type of data in the read MPEG stream, divides the MPEG stream into an audio stream, a video stream, and other data streams, and decodes each of the streams (steps S205 to S207). One option is that: the MPEG-stream writer 53 divides each MPEG stream into an audio stream, a video stream, and other data streams, and writes each stream in the corresponding zone in the memory 51, in the MPEG-stream writing procedure shown in FIG. 14; then, the MPEG decoder 11 reads each stream from the corresponding zone in the memory 51, in the decoding procedure.

In S204, the CPU 50 designates parameters, such as, a writing start position and a writing size of each stream per unit of processing (for example, per audio frame for an audio stream, per frame or field for a video stream, and per data size for other data streams).

In S205, the CPU 50 instructs the MPEG decoder 11 to start decoding per unit of processing. The MPEG decoder 11 decodes each stream per unit of processing and writes each decoded stream in a designated address in the memory 51, optionally writing intermediate data in a work memory 52. Moreover, the CPU 50 stores several types of coding parameters carried by the streams in the memory 51 or registers in the MPEG decoder 11. The coding parameters include the picture-type information on picture types as which each frame (or fields of this frame) has (or have) been coded.

The CPU 50 determines whether the decoding procedure is complete per unit of processing (S206). If not (NO in S206), the CPU 50 goes back to step S204. If complete (YES in S206), the CPU 50 goes to step S207.

The CPU 50 determines whether the decoding and writing procedures are complete for all of the streams to be decoded (S207). If not (NO in S207), the CPU 50 goes back to step S204. If complete (YES in S207), the CPU 50 goes to step S208 to finish the MPEG-stream decoding procedure.

[DV Coding Procedure]

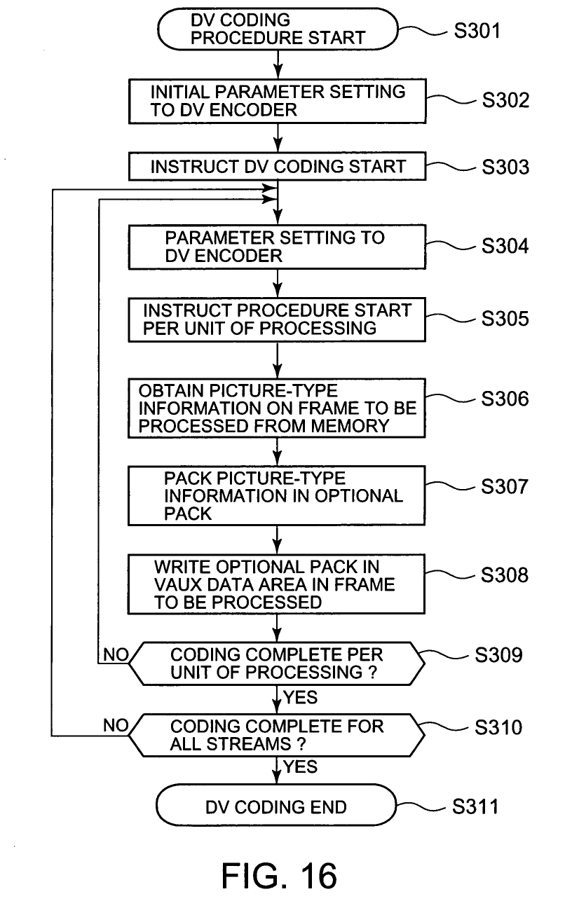

Disclosed next is a DV coding procedure, with reference to FIG. 13 and the flowchart shown in FIG. 16.

The CPU 50 starts a DV coding procedure (step S301).

The CPU 50 sets initial parameters to the DV encoder 13 (FIG. 3) per unit of processing (step S302). The parameters include a top address of each of decoded streams stored in the corresponding zone in the memory 51.

The CPU 50 instructs the DV encoder 13 to start DV coding to the streams stored in the memory 51 (step S303).

The CPU 50 sets parameters to the DV encoder 13 per frame for a video stream, per audio frame for an audio stream, and per unit of information related to each frame for other data streams (step S304). Then, the CPU 50 instructs the DV encoder 13 to start DV coding per unit of procedure (step S305).

The CPU 50 retrieves the picture-type information (I-picture, p-picture or B-picture of a video stream when coded previously) among the parameters corresponding to each frame of the video stream, from the memory 51 or the register of the MPEG decoder 11 (step S306).

Then, the CPU 50 packs the picture-type information in an optional pack in VAUX BINARY GROUP (step S307). The CPU 50 writes the packed picture-type information as VAUX data (pack data) accessible in relation to each frame of the video stream, in the memory 51 (step S308).

Step S308 is executed in order for the CPU 50 to access the VAUX data according to information in a work area to know where the VAUX data is stored in the memory 51, in order to process both of each frame of DV-coded the video stream and the corresponding VAUX data as information on the this frame.

Throughout the disclosure, the expression “data (or information) accessible in relation to each frame (or filed)” means that the data (or information) is stored in the memory 51 so that the CPU 50 can access the data (or information) in relation to each frame (or filed).

Accordingly, the CPU 50 can retrieve data of each stream from the memory 51 for each frame and encode each data related to the same frame as data included in this frame when multiplexing a video stream, an audio stream and other streams coded in the DV format into one DV coded stream (DV data) that is sent to a DV-data output unit 54. The multiplex processing may be performed with retrieving each stream from the memory 51 in a predetermined order or from the DV-data output unit 54 to which the CPU 50 sends necessary parameters and a starting instruction per unit of processing.

The CPU 50 determines whether the DV coding procedure is complete per unit of processing (S309). If not (NO in S309), the CPU 50 goes back to step S304. If complete (YES in S309), the CPU 50 goes to step S310.

The CPU 50 determines whether the DV coding procedure is complete for all of the streams (S310). If not (NO in S310), the CPU 50 goes back to step S304. If complete (YES in S310), the CPU 50 goes to step S311 to finish the DV coding procedure.

The CPU 50 sends the coded DV data to the recording controller 18 via the DV-data output unit 54 to record the data in the storage medium 14 or transfers the data outside via the digital I/F 20. In this case, the DV encoder 13 may temporarily store the DV data in the memory 51 and then the DV-data output unit 54 retrieves the DV data from the memory 51 or the DV encoder 13 may send the DV data to the DV-data output unit 54 without temporarily storing the DV data in the memory 51.

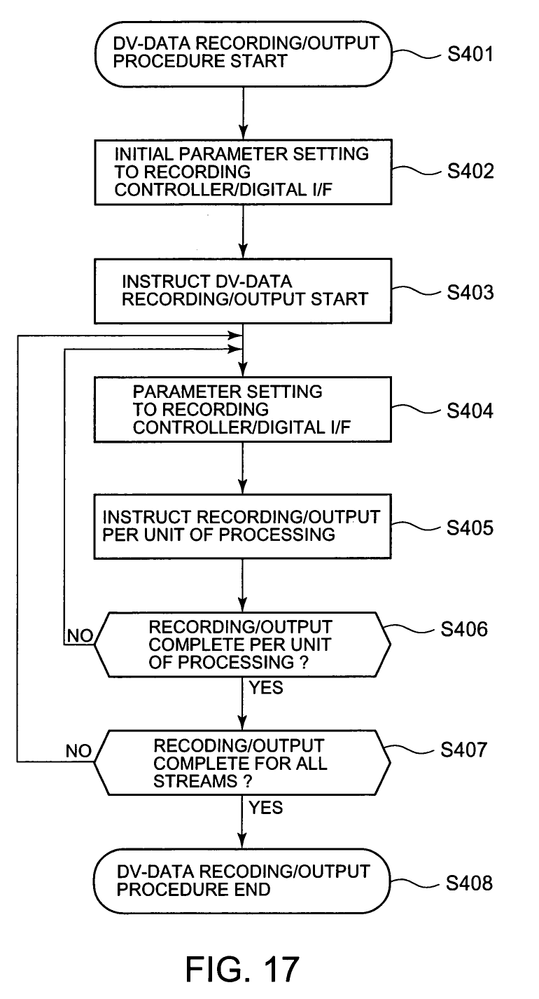

FIG. 17 shows a flowchart for explaining a DV-data output procedure. The detailed explanation of this procedure is omitted because it is not an essential part of the present invention.

In the disclosure above, the CPU 50 controls the hardware, such as, the MPEG decoder 11, the DV encoder 13, etc., which, however, be achieved partially or completely with software installed in the CPU 50 (or DSP).

A program for controlling the MPEG decoder 11 or achieving MPEG decoding and a program for controlling the DV encoder 13 or achieving DV coding may be combined into one program (with a multi-task procedure) or separated from each other.

The MPEG decoding and DV coding procedures may be executed by separate CPUs instead of the single CPU 50.

The MPEG decoding and DV coding procedures are performed substantially simultaneously although the DV coding procedure is performed to an MPEG-decoded stream and hence is very slightly delayed from the MPEG decoding procedure.

The DV coding procedure may be performed after the completion of the MPEG decoding procedure for all MPEG streams when there is an enough storage area in the memory 51 for storing MPEG-decoded streams and their related information such as the picture-type information.

Described next in detail is the DV-to-MPEG decoding apparatus 22 shown in FIG. 3.

Supplied to DV-to-MPEG decoding apparatus 22 is DV data that carries a DV-coded moving-picture signal and pack information with picture-type information accessible in relation to each frame of the moving-picture signal, the picture-type information indicating a picture type of each frame (or fields) when each frame (or fields) was (or were) subjected to MPEG coding when the DV-coded moving-picture signal is a transcoded version of an MPEG-coded moving-picture signal.

The DV data is supplied to the reproduction controller 19 from the MPEG-to-DV coding apparatus 21 via the storage medium 14 or to the digital I/F 20a via the counterpart 20 of the apparatus 21.

The DV data is then supplied to the DV decoder 15 from the reproduction controller 19 or the digital I/F 20a. The DV decoder 15 decodes the input DV data to obtain decoded moving-picture data and decoded pack information corresponding to decoded frames of the moving-picture data. The decoded moving-picture data and the decoded pack information are supplied to the MPEG encoder 17 and the pack-data extractor 16, respectively.

The pack-data extractor 16 detects a pack that carries the picture-type information from the decoded pack information to obtain picture-type information on each filed and supplies this picture-type information to the MPEG encoder 17.

The MPEG encoder 17 encodes the decoded moving-picture data supplied from the DV decoder 15 per frame or field according to the picture-type information supplied from the pack-data extractor 16.

The DV-to-MPEG coding apparatus 22 shown in FIG. 3 is disclosed further in detail.

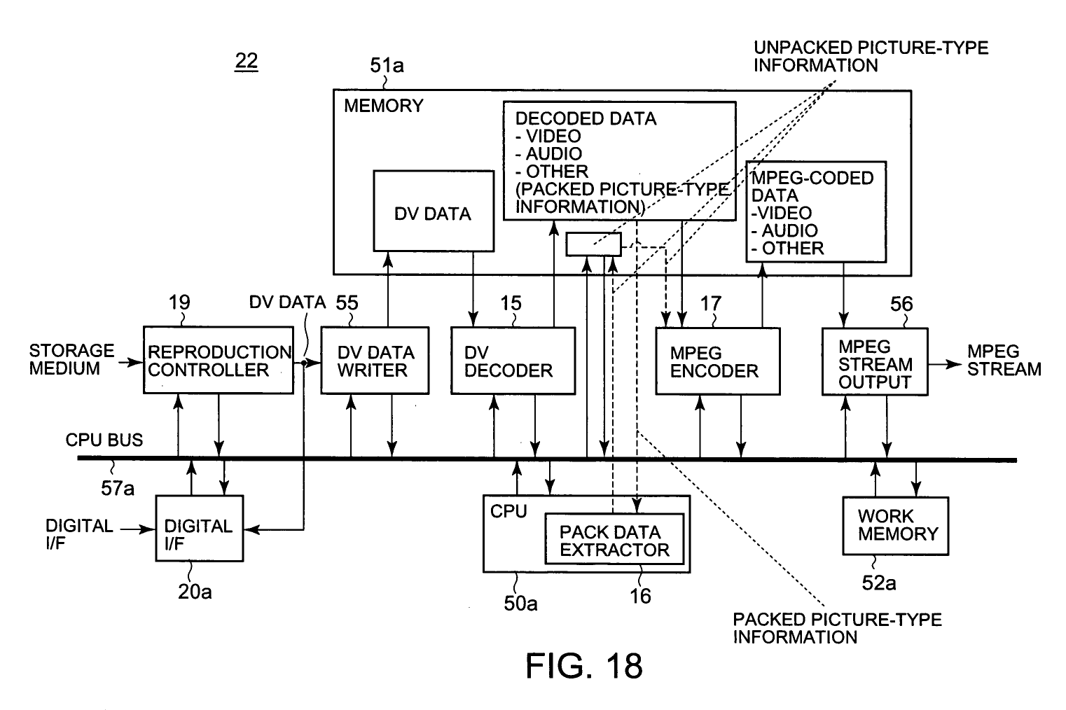

FIG. 18 shows a block diagram indicating a detailed structure of the DV-to-MPEG coding apparatus 22. Each block in FIG. 18 is under control by a CPU 50a via a CPU bus 57a. The CPU 50a further functions as the pack-data extractor 16 shown in FIG. 3. The CPU 50a may also be replaced by a DSP.

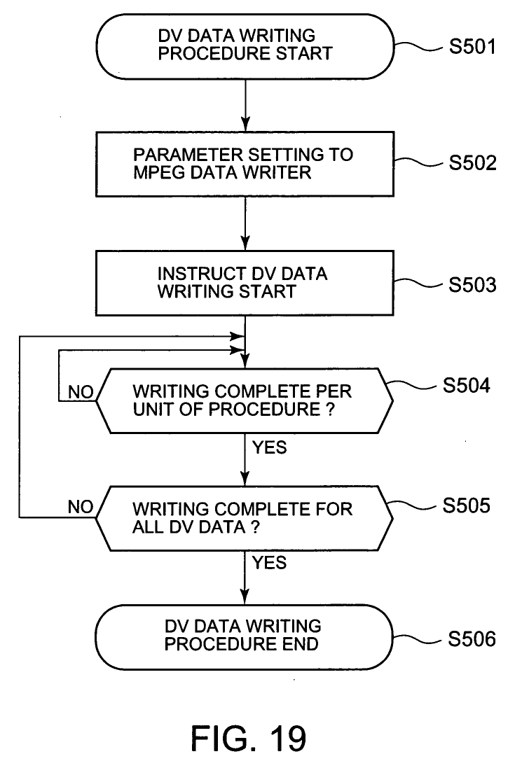

The function of the DV-to-MPEG coding apparatus 22, or the CPU 50a, will be disclosed with reference to FIG. 18 and also flowcharts shown in FIGS. 19 to 21.

[DV-Data Writing Procedure]

Disclosed first is a DV-data writing procedure to write an input DV data in the memory 51a, with reference to FIG. 18 and the flowchart shown in FIG. 19.

The CPU 50a starts a DV-data writing procedure (step S501).

The CPU 50a sets several parameters to a DV-data writer 55 per unit of processing to the input DV data (step S502). The parameters are a writing start position, a writing size per unit of processing of the input DV data to the memory 51a, etc.

The CPU 50a instructs the DV-data writer 55 to start a DV-data writing procedure (step S503).

On receiving the instruction from the CPU 50a, the DV-data writer 55 starts writing and repeats the writing procedure from a designated writing start point in the memory 51a according to the type of data, such as, video, audio and system data at a specific unit of processing to each data type (steps S504 and S505).

The CPU 50a finishes the DV-data writing procedure when it determines that all DV data have been written (step S506).

[DV-Data Decoding Procedure]

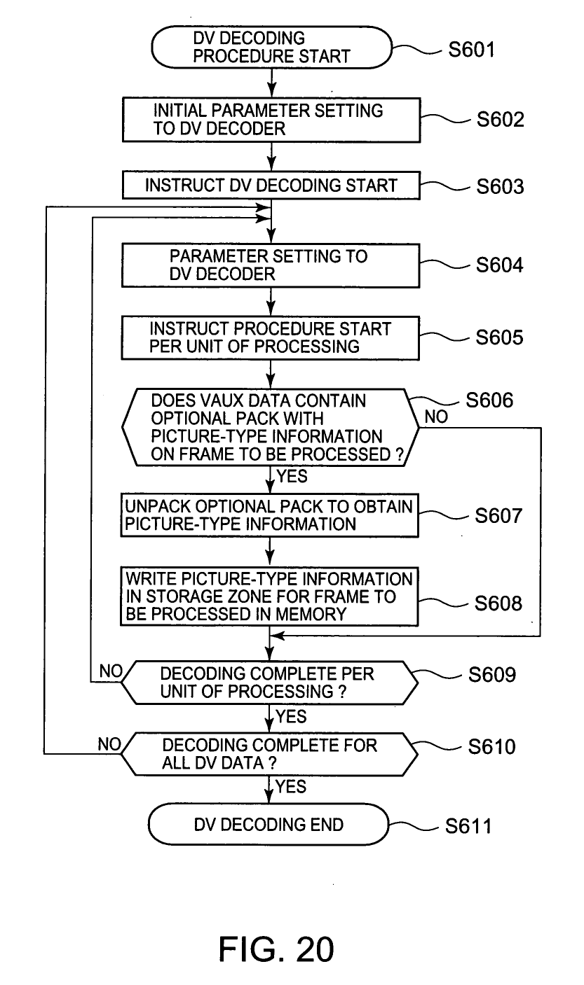

Disclosed next is a DV-data decoding procedure to decode DV data written in the memory 51a, with reference to FIG. 18 and the flowchart shown in FIG. 20.

The CPU 50a starts a DV-data decoding procedure (step S601).

The CPU 50a sets several initial parameters to the DV decoder 15 decoder 15 (FIG. 3) per unit of processing (step S602). The parameters are a reading start position, a reading size (depending on the unit of processing) of the DV data written in the memory 51a, etc.

The CPU 50a instructs the DV decoder 15 to start DV-data decoding (step S603).

The CPU 50a sets the parameters mentioned above to the DV decoder 15 when the reading size varies per unit of processing (step S604). When the reading size is constant, however, step S604 may not be executed, the initial parameter settings (step S602) only being executed.

On receiving the instruction from the CPU 50a, the DV decoder 15 reads DV data from a designated reading start point in the memory 51a depending on a specific unit of processing for each of the video, audio and system data and decodes each data (steps S605 to S611).

In S605, the DV decoder 15 stores decoded video stream, audio stream and system-data stream in the respectively designated zones in the memory 51a.

Then, in S606, the CPU 50a determines whether there is picture-type information on the system data. If there is such picture-type information, the CPU 50a determines that the decoded streams were once coded with two types of coding schemes: intra-picture and inter-picture coding schemes, represented by MPEG, for example. The picture-type information on the system data is used in the procedure as described below.

In detail, in S606, the CPU 50a retrieves the system data decoded by the DV decoder 15 and stored in the memory 51a or the (pre-decoded) system data stored in the memory 51a by the DV-data writer 55 and determines whether there is an optional pack that carries the picture-type information in VAUX data in the system data for each frame to be decoded. If there is such an optional pack (YES in S606), the CPU 50a unpacks the optional pack (S607), and stores the unpacked optional pack in the memory 51a or in a temporal storage zone corresponding to each frame in the CPU 50a (S608).

Then, in S609, the CPU 50a determines whether the DV-data decoding procedure is complete for each specific unit of processing. If not (NO in S609), the CPU 50a goes back to step S604. If complete (YES in S609), the CPU 50a goes to step S604.

In S610, the CPU 50a determines whether the DV-data decoding procedure is complete for all of the DV data to be decoded. If not (NO in S610), the CPU 50a goes back to step S604. If complete (YES in S610), the CPU 50a goes to step S611 to finish the DV-data decoding procedure.

[MPEG Coding Procedure]

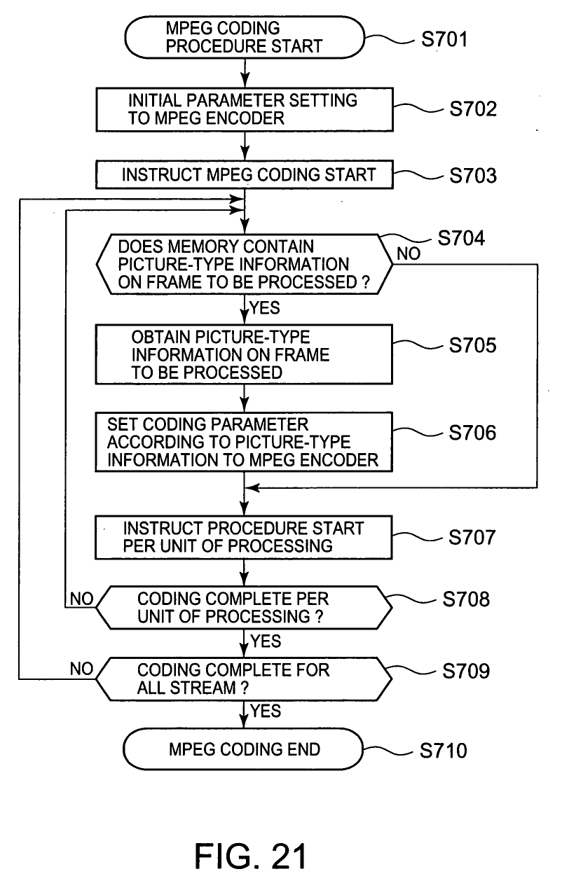

Disclosed next is an MPEG coding procedure, with reference to FIG. 18 and the flowchart shown in FIG. 21.

The CPU 50a starts an MPEG coding procedure (step S701).

The CPU 50a sets initial parameters to the MPEG encoder 17 (FIG. 3) per unit of processing (step S702). The parameters include a top address of each decoded stream stored in a designated zone in the memory 51a.

The CPU 50a instructs the MPEG encoder 17 to start the MPEG coding procedure to each stream stored in the memory 51a per unit of processing (step S703).

The CPU 50a determines whether the picture-type information on each frame of the video stream is located in the memory 51a or the temporal storage zone in the CPU 50a (step S704). If the picture-type information is located (YES in S704), the CPU 50a goes to step S705. If not (NO in S704), the CPU 50a jumps to step S707.

In S705, the CPU 50a retrieves the stored picture-type information.

Then, the CPU 50a sets a coding parameter according to the retrieved picture-type information to the MPEG encoder 17 (step S706).

In S707, the CPU 50a instructs the MPEG encoder 17 to start MPEG coding per unit of procedure so that the picture type of each frame or field to be coded matches the designated picture type in frame or field according to the set picture-type information.

Then, the CPU 50a determines whether the MPEG coding procedure is complete per unit of processing (S708). If not (NO in S708, the CPU 50a goes back to step S704. If complete (YES in S708), the CPU 50a goes to step S709.

In S709, the CPU 50a determines whether the MPEG coding procedure is complete for all of the streams to be coded. If not (NO in S709), the CPU 50a goes back to step S704. If complete (YES in S709), the CPU 50a goes to step S710 to finish the MPEG coding procedure.

In the disclosure above, the CPU 50a controls the hardware, such as, the DV decoder 15, the MPEG encoder 17, etc., which, however, be achieved partially or completely with software installed in the CPU 50a (or DSP).

A program for controlling the DV decoder 15 or achieving DV decoding and a program for controlling the MPEG encoder 17 or achieving MPEG coding may be combined into one program (with a multi-task procedure) or separated from each other.

The DV decoding and MPEG coding procedures may be executed by separate CPUs instead of the single CPU 50a.

The DV decoding and MPEG coding procedures are performed substantially simultaneously although the MPEG coding procedure is performed to a DV-decoded stream and hence is very slightly delayed from the DV decoding procedure.

The MPEG coding procedure may be performed after the completion of the DV decoding procedure for all of the DV data when there is an enough storage area in the memory 51a for storing DV-decoded streams and their related information such as the picture-type information.

As disclosed above, in FIG. 3, each picture of an output MPEG stream, that is a moving-picture coded data strain obtained by MPEG coding at the MPEG encoder 17, is picture data coded in the same picture type as each picture of an input MPEG stream to the MPEG decoder 11, according to the picture-type information extracted by the pack-data extractor 16. Therefore, when the output MPEG stream is decoded, the decrease in picture quality is restricted very much, as discussed with respect to FIG. 2.

In the embodiment of the present invention, the picture-type information (auxiliary information) is transferred as being carried by pack data available in the coding and decoding standards, thus transfer of auxiliary information being achieved with no increase in data amount.

The embodiment of the present invention employs: the MPEG coding scheme that corresponds to the claimed first coding scheme with intra- and inter-picture coding techniques; and the DV coding scheme that corresponds to the claimed second coding scheme with an intra-picture coding technique only. Not only the MPEG and the DV coding schemes, any coding schemes can be employed as the first and second coding schemes in the present invention as long as one coding scheme is a combination of intra- and inter-picture coding techniques and the other is an intra-picture coding technique only.

The embodiment of the present invention employs the same coding scheme with the same intra- and inter-picture coding techniques, such as the MPEG coding scheme, before and after transcoding. The coding schemes employed before and after transcoding may, however, not be the same as each other in the present invention. In other words, different coding schemes (corresponding to the claimed first and third coding schemes) can be employed before and after transcoding in the present invention as long as the coding schemes encode pictures in types of I-, P- and B-pictures, etc. For example, the present invention is achievable in transcoding of an MPEG stream to a DV stream and then to an H.264 stream.

The most appropriate mode in the present invention is that a re-coded picture type matches an original picture type, as discussed with respect to FIG. 2. However, it depends on re-coding architecture, and P- and B-pictures that require a complex procedure can be processed as I-pictures when the same sequence cannot be applied before and after transcoding, for example, due to lack of hardware resources, in the present invention. Thus, the present invention allows a re-coding procedure even with lack of processing resources, for maintaining original picture quality as much as possible.

Moreover, the present invention is achievable with software programs running on computer that executes the functions of the apparatuses disclosed above. Such software can be installed in a computer via a storage medium or a communications network. Here, the computer is representative of apparatuses, such as, a CPU or a DSP, that executes several procedures sequentially depending on the contents of programs and system conditions, which may physically be one block in an LSI, the enter LSI or an external apparatus.

As disclosed above in detail, according to the present invention, the picture-type information on frame or filed pictures can be maintained for moving-picture signals once coded with an inter-picture coding scheme such as MPEG and then re-coded with an intra-picture coding scheme such as DV, with no increase of code amount.

Moreover, according to the present invention, moving-picture signals coded with an intra-picture coding scheme and carrying picture-type information indicating the picture types of the moving-picture signals once coded with an inter-picture coding scheme can be re-coded with an inter-picture coding scheme with the picture-type information, thus decrease in picture quality after re-coding is restricted significantly.

What is claimed is:

1. A moving-picture coding apparatus comprising:
a decoder to decode a first stream carrying moving-picture signals coded with a first coding scheme with a first intra-picture coding technique and an inter-picture coding technique, thus generating decoded moving-picture data;
a generator to generate picture-type information on each frame or field picture of the decoded moving-picture data, the picture-type information indicating a first picture type or a second picture type, the first picture type being for each picture coded with the first intra-picture coding technique and the second picture type being for each picture coded with the inter-picture coding technique; and
an encoder to encode the decoded moving-picture data with a second coding scheme with a second intra-picture coding technique, thus generating a second stream, and create auxiliary information areas in the second stream, each auxiliary information area being accessible in relation to each picture of the decoded moving-picture data, and insert the picture-type information into the auxiliary information areas.

2. The moving-picture coding apparatus according to claim 1, wherein the generator generates the picture-type information based on auxiliary information accessible in relation to each picture of the first stream.

3. A moving-picture coding apparatus comprising:
a decoder to decode a first stream that is originally moving-picture data coded with a first coding scheme with a first intra-picture coding technique and an inter-picture coding technique and then coded again, after decoded, with a second coding scheme with a second intra-picture coding technique, thus generating decoded moving-picture data;
an extractor to extract picture-type information from the first stream, the picture-type information being inserted into auxiliary information areas of the first stream, the auxiliary information areas being accessible in relation to each frame or field picture of the decoded moving-picture data, the picture-type information indicating a first picture type or a second picture type, the first picture type being for each picture coded with the first intra-picture coding technique and the second picture type being for each picture coded with the inter-picture coding technique; and
an encoder to encode the decoded moving-picture data with the first coding scheme according to the picture-type information, thus generating a second stream.

4. The moving-picture coding apparatus according to claim 3, wherein the encoder determines whether it is possible to encode each picture of the decoded moving-picture data according to the picture-type information, and encodes a picture or pictures as having the first picture type, which is or are determined as not possible to be encoded according to the picture-type information.

5. A moving-picture coding apparatus comprising:
a decoder to decode a first stream that is originally moving-picture data coded with a first coding scheme with first intra-picture coding and inter-picture coding techniques and then coded again, after decoded, with a second coding scheme with a second intra-picture coding technique, thus generating decoded moving-picture data;
an extractor to extract picture-type information from the first stream, the picture-type information being inserted into auxiliary information areas of the first stream, the auxiliary information areas being accessible in relation to each frame or field picture of the decoded moving-picture data, the picture-type information indicating a first picture type or a second picture type, the first picture type being for each picture coded with the first intra-picture coding technique and the second picture type being for each picture coded with the first inter-picture coding technique; and
an encoder to encode the decoded moving-picture data with a third coding scheme with a third intra-picture coding technique and a second inter-picture coding technique, different from the first coding scheme, according to the picture-type information, thus generating a second stream.

6. The moving-picture coding apparatus according to claim 5, wherein the encoder determines whether it is possible to encode each picture of the decoded moving-picture data according to the picture-type information, and encodes a picture or pictures as having the first picture type, which is or are determined as not possible to be encoded according to the picture-type information.

7. A moving-picture coding method comprising the steps of:
decoding a first stream carrying moving-picture signals coded with a first coding scheme with a first intra-picture coding and an inter-picture coding technique, thus generating decoded moving-picture data;
generating picture-type information on each frame or field picture of the decoded moving-picture data, the picture-type information indicating a first picture type or a second picture type, the first picture type being for each picture coded with the first intra-picture coding technique and the second picture type being for each picture coded with the inter-picture coding technique; and
encoding the decoded moving-picture data with a second coding scheme with a second intra-picture coding technique, thus generating a second stream, and creating auxiliary information areas in the second stream, each auxiliary information area being accessible in relation to each picture of the decoded moving-picture data, and inserting the picture-type information into the auxiliary information areas.

8. The moving-picture coding method according to claim 7, wherein the generating step generates the picture-type information based on auxiliary information accessible in relation to each picture of the first stream.

9. A moving-picture coding method comprising the steps of:
decoding a first stream that is originally moving-picture data coded with a first coding scheme with a first intra-picture coding technique and an inter-picture coding technique and then coded again, after decoded, with a second coding scheme with a second intra-picture coding technique, thus generating decoded moving-picture data;
extracting picture-type information from the first stream, the picture-type information being inserted into auxiliary information areas of the first stream, the auxiliary information areas being accessible in relation to each frame or field picture of the decoded moving-picture data, the picture-type information indicating a first picture type or a second picture type, the first picture type being for each picture coded with the first intra-picture coding technique and the second picture type being for each picture coded with the inter-picture coding technique; and
encoding the decoded moving-picture data with the first coding scheme according to the picture-type information, thus generating a second stream.

10. The moving-picture coding method according to claim 9, wherein the encoding step including the step of determining whether it is possible to encode each picture of the decoded moving-picture data according to the picture-type information, thus encoding a picture or pictures as having the first picture type, which is or are determined as not possible to be encoded according to the picture-type information.

11. A moving-picture coding method comprising the steps of:
decoding a first stream that is originally moving-picture data coded with a first coding scheme with first intra-picture coding and inter-picture coding techniques and then coded again, after decoded, with a second coding scheme with a second intra-picture coding technique, thus generating decoded moving-picture data;
extracting picture-type information from the first stream, the picture-type information being inserted into auxiliary information areas of the first stream, the auxiliary information areas being accessible in relation to each frame or field picture of the decoded moving-picture data, the picture-type information indicating a first picture type or a second picture type, the first picture type being for each picture coded with the first intra-picture coding technique and the second picture type being for each picture coded with the first inter-picture coding technique; and
encoding the decoded moving-picture data with a third coding scheme with a third intra-picture coding technique and a second inter-picture coding technique, different from the first coding scheme, according to the picture-type information, thus generating a second stream.

12. The moving-picture coding method according to claim 11, wherein the encoding step including the step of determining whether it is possible to encode each picture of the decoded moving-picture data according to the picture-type information, thus encoding a picture or pictures as having the first picture type, which is or are determined as not possible to be encoded according to the picture-type information.

13. A moving-picture coding program, in a computer readable medium, for encoding moving-picture signals comprising:
a decoding program code of decoding a first stream carrying moving-picture signals coded with a first coding scheme with a first intra-picture coding technique and an inter-picture coding technique, thus generating decoded moving-picture data;
a generating program code of generating picture-type information on each frame or field picture of the decoded moving-picture data, the picture-type information indicating a first picture type or a second picture type, the first picture type being for each picture coded with the first intra-picture coding technique and the second picture type being for each picture coded with the inter-picture coding technique; and
an encoding program code of encoding the decoded moving-picture data with a second coding scheme with a second intra-picture coding technique, thus generating a second stream, and creating auxiliary information areas in the second stream, each auxiliary information area being accessible in relation to each picture of the decoded moving-picture data, and inserting the picture-type information into the auxiliary information areas.

14. The moving-picture coding program according to claim 13, wherein the generating program code generates the picture-type information based on auxiliary information accessible in relation to each picture of the first stream.

15. The moving-picture coding program according to claim 13, wherein either the decoding program code or the encoding program code runs on a computer and the other runs on another computer or both of the decoding and encoding program codes run on a computer with a multi-task procedure.

16. A moving-picture coding program, in a computer readable medium, for encoding moving-picture signals comprising:
a decoding program code of decoding a first stream that is originally moving-picture data coded with a first coding scheme with a first intra-picture coding technique and an inter-picture coding technique and then coded again, after decoded, with a second coding scheme with a second intra-picture coding technique, thus generating decoded moving-picture data;
an extracting program code of extracting picture-type information from the first stream, the picture-type information being inserted into auxiliary information areas of the first stream, the auxiliary information areas being accessible in relation to each frame or field picture of the decoded moving-picture data, the picture-type information indicating a first picture type or a second picture type, the first picture type being for each picture coded with the first intra-picture coding technique and the second picture type being for each picture coded with the inter-picture coding technique; and
an encoding program code of encoding the decoded moving-picture data with the first coding scheme according to the picture-type information, thus generating a second stream.

17. The moving-picture coding program according to claim 16, wherein the encoding program code includes the program code of determining whether it is possible to encode each picture of the decoded moving-picture data according to the picture-type information, thus encoding a picture or pictures as having the first picture type, which is or are determined as not possible to be encoded according to the picture-type information.

18. The moving-picture coding program according to claim 16, wherein either the decoding program code or the encoding program code runs on a computer and the other runs on another computer or both of the decoding and encoding program codes run on a computer with a multi-task procedure.

19. A moving-picture coding program, in a computer readable medium, for encoding moving-picture signals comprising:
a decoding program code of decoding a first stream that is originally moving-picture data coded with a first coding scheme with first intra-picture coding and inter-picture coding techniques and then coded again, after decoded, with a second coding scheme with a second intra-picture coding technique, thus generating decoded moving-picture data;
an extracting program code of extracting picture-type information from the first stream, the picture-type information being inserted into auxiliary information areas of the first stream, the auxiliary information areas being accessible in relation to each frame or field picture of the decoded moving-picture data, the picture-type information indicating a first picture type or a second picture type, the first picture type being for each picture coded with the first intra-picture coding technique and the second picture type being for each picture coded with the first inter-picture coding technique; and
an encoding program code of encoding the decoded moving-picture data with a third coding scheme with a third intra-picture coding technique and a second inter-picture coding technique, different from the first coding scheme, according to the picture-type information, thus generating a second stream.

20. The moving-picture coding program according to claim 19, wherein the encoding program code includes the program code of determining whether it is possible to encode each picture of the decoded moving-picture data according to the picture-type information, thus encoding a picture or pictures as having the first picture type, which is or are determined as not possible to be encoded according to the picture-type information.

21. The moving-picture coding program according to claim 19, wherein either the decoding program code or the encoding program code runs on a computer and the other runs on another computer or both of the decoding and encoding program codes run on a computer with a multi-task procedure.
